(19) United States
(12) Patent Application Publication
(10) Pub. No.: US 2014/0243472 A1
(43) Pub. Date: Aug. 28, 2014

(54) SURFACE PROTECTIVE FILM

(71) Applicant: NITTO DENKO CORPORATION, Osaka (JP)

(72) Inventors: Souya JO, Ibaraki-shi (JP); Koji SHITARA, Ibaraki-shi (JP); Noritsugu DAIGAKU, Ibaraki-shi (JP); Tadatoshi NAKANISHI, Ibaraki-shi (JP); Shou UCHIDA, Ibaraki-shi (JP); Shogo SASAKI, Ibaraki-shi (JP); Ryohei SAWAZAKI, Ibaraki-shi (JP)

(73) Assignee: NITTO DENKO CORPORATION, Osaka (JP)

(21) Appl. No.: 14/177,623

(22) Filed: Feb. 11, 2014

(30) Foreign Application Priority Data
Feb. 22, 2013 (JP) 2013-033025

(51) Int. Cl. C09J 175/04; C09J 133/00

(52) U.S. Cl. CPC C09J 175/04; C09J 133/00
USPC 524/590; 528/85; 525/123

(57) ABSTRACT

Provided is a surface protective film including, as an outermost layer, a pressure-sensitive adhesive layer containing a urethane-based pressure-sensitive adhesive as a main component, the surface protective film allowing the contamination of an adherend to be extremely suppressed, and being preferably excellent in wettability and reworkability. The surface protective film of the present invention includes, as an outermost layer, a pressure-sensitive adhesive layer containing, as a main component, a urethane-based pressure-sensitive adhesive containing a polyurethane-based resin; and when a pressure-sensitive adhesive layer side of the surface protective film is attached to a glass plate at 50° C. for 10 days and then the surface protective film is peeled from the glass plate, a residual adhesive strength on the peeled surface side of the glass plate is 3.0 N/19 mm or more.

This application claims priority under 35 U.S.C. Section 119 to Japanese Patent Application No. 2013-033025 filed on Feb. 22, 2013, which is herein incorporated by reference.

### BACKGROUND OF THE INVENTION

1. Field of the Invention

The present invention relates to a surface protective film. The surface protective film of the present invention includes, as an outermost layer, a pressure-sensitive adhesive layer containing, as a main component, a urethane-based pressure-sensitive adhesive containing a polyurethane-based resin. The surface protective film of the present invention is preferably used for, for example, protecting a surface of a thin display member, a thin display apparatus, a thin optical film, or an electronic device.

2. Description of the Related Art

Optical members and electronic members such as a thin display member, a thin display apparatus, a thin optical film, and an electronic device may each generally have a surface protective film attached onto an exposed surface side thereof in order to prevent a flaw from occurring on a surface thereof upon processing, assembly, inspection, transportation, or the like. Such surface protective film is peeled from the optical member or the electronic member when the need for surface protection is eliminated.

In more and more cases, the same surface protective film is continuously used as such surface protective film, from a manufacturing step of the optical member or the electronic member, through an assembly step, an inspection step, a transportation step, and the like, until final shipping. In many of such cases, such surface protective film is attached, peeled off, and re-attached by manual work in each step.

When the surface protective film is attached by manual work or when the surface protective film is attached to a large adherend, air bubbles may be trapped between the adherend and the surface protective film. Accordingly, there have been reported some technologies for improving wettability of a surface protective film so that air bubbles may not be trapped upon the attachment. For example, there is known a surface protective film that uses a silicone resin, which has a high wetting rate, in a pressure-sensitive adhesive layer (see, for example, JP 2006-152266 A).

However, when the silicone resin is used in the pressure-sensitive adhesive layer, its pressure-sensitive adhesive component is liable to contaminate the adherend, resulting in a major problem when the surface protective film is used for protecting a surface of a member for which particularly low contamination is required, such as the optical member or the electronic member.

As a surface protective film that causes less contamination derived from its pressure-sensitive adhesive component, there is known a surface protective film that uses an acrylic resin in a pressure-sensitive adhesive layer (see, for example, JP 2004-051825 A). However, the surface protective film that uses the acrylic resin in the pressure-sensitive adhesive layer is poor in wettability, and hence, when the surface protective film is attached by manual work, air bubbles may be trapped between the adherend and the surface protective film. In addition, when the acrylic resin is used in the pressure-sensitive adhesive layer, there is a problem in that an adhesive residue is liable to occur upon peeling, resulting in a problem when the surface protective film is used for protecting a surface of a member for which incorporation of foreign matter is particularly undesirable, such as the optical member or the electronic member.

By the way, when the surface protective film is attached to an adherend, light-peeling property is required as well as excellent wettability such as the initial wettability as described above. This is because the surface protective film is prevented from damaging to an adherend upon peeling, and is, after being peeled off, re-attached to the adherend to serve again as a surface protective film. Even with good wettability, in the case of a thin and brittle adherend, the adherend is broken, or the surface protective film deforms upon peeling of the surface protective film when the peeling is heavy, and thus the film cannot be used again as a surface protective film. In order to avoid such problem, the surface protective film to be used for an optical member or an electronic member is strongly required to have so-called reworkability of being able to be attached many times without trapping air bubbles and being able to be lightly peeled off without deforming.

### SUMMARY OF THE INVENTION

An object of the present invention is to provide a surface protective film including, as an outermost layer, a pressure-sensitive adhesive layer containing a urethane-based pressure-sensitive adhesive as a main component, the surface protective film allowing the contamination of an adherend to be extremely suppressed, and being preferably excellent in wettability and reworkability.

A surface protective film according to one embodiment of the present invention includes, as an outermost layer, a pressure-sensitive adhesive layer,

in which:

the pressure-sensitive adhesive layer contains, as a main component, a urethane-based pressure-sensitive adhesive containing a polyurethane-based resin; and

when a pressure-sensitive adhesive layer side of the surface protective film is attached to a glass plate at 50° C. for 10 days and then the surface protective film is peeled from the glass plate, a residual adhesive strength on the peeled surface side of the glass plate is 3.0 N/19 mm or more.

In one exemplary embodiment, the surface protective film of the present invention has a wetting rate with respect to a glass plate of 1.0 cm/sec or more.

In one exemplary embodiment, the surface protective film of the present invention has an initial pressure-sensitive adhesive strength with respect to a glass plate of 0.10 N/25 mm or less.

In one exemplary embodiment, the surface protective film of the present invention has a pressure-sensitive adhesive strength with respect to a glass plate after attachment at 50° C. for 10 days of 0.15 N/25 mm or less.

In one exemplary embodiment, the polyurethane-based resin is a polyurethane-based resin obtained from a composition containing polyol (A) and a polyfunctional isocyanate compound (B).

In one exemplary embodiment, the polyurethane-based resin is a polyurethane-based resin obtained from a composition containing a urethane prepolymer (C).

In one exemplary embodiment, the polyurethane-based resin contains a leveling agent.

In one exemplary embodiment, the surface protective film of the present invention is used for protecting a surface of a thin display member, a thin display apparatus, a thin optical film, or an electronic device.

According to the present invention, there may be provided a surface protective film including, as an outermost layer, a pressure-sensitive adhesive layer containing, as a main component, a urethane-based pressure-sensitive adhesive, the surface protective film allowing the contamination of an adherend to be extremely suppressed, and being preferably excellent in wettability and reworkability.

### BRIEF DESCRIPTION OF THE DRAWINGS

FIG. 1 is a schematic sectional view of a surface protective film according to one exemplary embodiment of the present invention.

FIG. 2 is a schematic sectional view illustrating a state in which the pressure-sensitive adhesive layer surface of a test piece, part of which has been brought into contact with a glass plate as an adherend, is held with a hand so as to form an angle of 20° to 30° in the measurement of a wetting rate.

### DETAILED DESCRIPTION OF THE PREFERRED EMBODIMENTS

### Surface Protective Film

A surface protective film of the present invention includes a pressure-sensitive adhesive layer as an outermost layer.

The surface protective film of the present invention preferably includes a base material layer and the pressure-sensitive adhesive layer. The number of the base material layers may be only one, or may be two or more. The surface protective film of the present invention may include any appropriate other layer in addition to the base material layer and the pressure-sensitive adhesive layer as long as the effects of the present invention are not impaired.

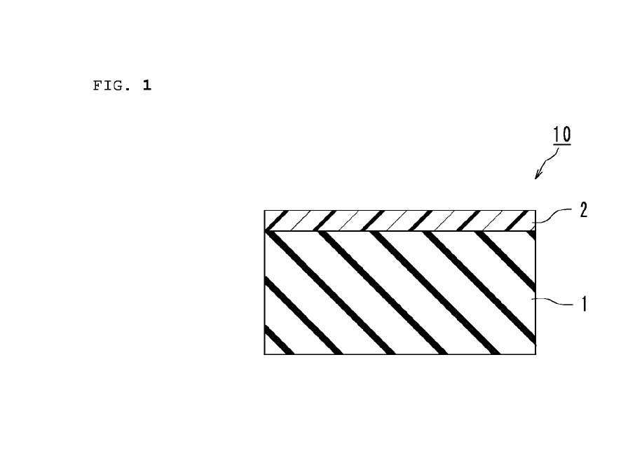

FIG. 1 is a schematic sectional view of a surface protective film according to one exemplary embodiment of the present invention. A surface protective film 10 includes a base material layer 1 and a pressure-sensitive adhesive layer 2. The surface protective film of the present invention may further include any appropriate other layer (not shown) as required.

The surface of the base material layer 1 on which the pressure-sensitive adhesive layer 2 is not provided may, for example, be subjected to a release treatment by adding a fatty acid amide, polyethyleneimine, a long-chain alkyl-based additive, or the like to the base material layer, or be provided with a coat layer formed of any appropriate releasing agent such as a silicone-based, long-chain alkyl-based, or fluorine-based releasing agent for the purpose of, for example, forming a roll body that can be easily rewound. A release liner having releasability may be attached to the surface protective film of the present invention.

The thickness of the surface protective film of the present invention may be set to any appropriate thickness depending on applications. From the viewpoint of sufficiently expressing the effects of the present invention, the thickness is preferably 10 μm to 300 μm, more preferably 15 μm to 250 μm, still more preferably 20 μm to 200 μm, particularly preferably 25 μm to 150 μm.

In the surface protective film of the present invention, when the pressure-sensitive adhesive layer side of the surface protective film is attached to a glass plate at 50° C. for 10 days and then the surface protective film is peeled from the glass plate, a residual adhesive strength on the peeled surface side of the glass plate is 3.0 N/19 mm or more, preferably 5.0 N/19 mm or more, more preferably 8.0N/19 mm or more. When the residual adhesive strength falls within the range, the surface protective film of the present invention allows the contamination of an adherend to be extremely suppressed. It should be noted that a measurement method for the residual adhesive strength is described later.

The surface protective film of the present invention has a wetting rate with respect to a glass plate of preferably 1.0 cm/sec or more, more preferably 2.0 cm/sec or more, still more preferably 3.0 cm/sec or more, particularly preferably 4.0 cm/sec or more. When the wetting rate falls within the range, the surface protective film of the present invention is excellent in wettability, and can effectively suppress the trapping of air bubbles upon attachment to an adherend. It should be noted that a measurement method for the wetting rate is described later.

The surface protective film of the present invention has an initial pressure-sensitive adhesive strength with respect to a glass plate of preferably 0.10 N/25 mm or less, more preferably 0.01 N/25 mm to 0.10 N/25 mm, still more preferably 0.01 N/25 mm to 0.05 N/25 mm, particularly preferably 0.01 N/25 mm to 0.04 N/25 mm, most preferably 0.01 N/25 mm to 0.03 N/25 mm. When the initial pressure-sensitive adhesive strength falls within the range, the surface protective film of the present invention is excellent in reworkability, can be attached many times without trapping air bubbles upon attachment to an adherend, and can allow light peeling without deformation. It should be noted that a measurement method for the initial pressure-sensitive adhesive strength is described later.

The surface protective film of the present invention has a pressure-sensitive adhesive strength with respect to a glass plate after attachment at 50° C. for 10 days of preferably 0.15 N/25 mm or less, more preferably 0.01 N/25 mm to 0.10 N/25 mm, still more preferably 0.01 N/25 mm to 0.05 N/25 mm. When the pressure-sensitive adhesive strength with respect to a glass plate after attachment at 50° C. for 10 days falls within the range, the surface protective film of the present invention is excellent in reworkability, can be attached many times without trapping air bubbles upon attachment to an adherend, and can allow light peeling without deformation. It should be noted that a measurement method for the pressure-sensitive adhesive strength is described later.

### <<Pressure-Sensitive Adhesive Layer>>

The pressure-sensitive adhesive layer contains, as a main component, a urethane-based pressure-sensitive adhesive containing a polyurethane-based resin. The content of the urethane-based pressure-sensitive adhesive in the pressure-sensitive adhesive layer is preferably 50 wt % to 100 wt %, more preferably 60 wt % to 100 wt %, still more preferably 70 wt % to 100 wt %, particularly preferably 80 wt % to 100 wt %, most preferably 90 wt % to 100 wt %. Any appropriate thickness can be adopted as the thickness of the pressure-sensitive adhesive layer depending on applications. The thickness of the pressure-sensitive adhesive layer is preferably 1 μm to 100 μm, more preferably 3 μm to 50 μm, still more preferably 5 μm to 30 μm.

The pressure-sensitive adhesive layer may be manufactured by any appropriate manufacturing method. An example of such manufacturing method is a method involving applying a composition that is a material for forming the pressure-sensitive adhesive layer onto the base material layer to form the pressure-sensitive adhesive layer on the base material layer. Examples of such application method include roll coating, gravure coating, reverse coating, roll brushing, spray coating, air knife coating, and extrusion coating with a die coater.

The pressure-sensitive adhesive layer may contain any appropriate other component in addition to the urethane-based pressure-sensitive adhesive as long as the effects of the present invention are not impaired. Examples of such other component include a resin component other than the urethane-based pressure-sensitive adhesive, a tackifier, an inorganic filler, an organic filler, metal powder, a pigment, a foil-shaped material, a softener, a plasticizer, an age resistor, a conductive agent, a UV absorbing agent, an antioxidant, alight stabilizer, a surface lubricating agent, a leveling agent, a corrosion inhibitor, a heat stabilizer, a polymerization inhibitor, a lubricant, and a solvent.

The content of the polyurethane-based resin in the urethane-based pressure-sensitive adhesive is preferably 50 wt % to 100 wt %, more preferably 70 wt % to 100 wt %, still more preferably 90 wt % to 100 wt %, particularly preferably 95 wt % to 100 wt %, most preferably 98 wt % to 100 wt %. Adjusting the content of the polyurethane-based resin in the urethane-based pressure-sensitive adhesive within the range allows the surface protective film of the present invention to contaminate an adherend to an additionally low extent, and to be preferably additionally excellent in wettability and reworkability.

Any appropriate polyurethane-based resin may be adopted as the polyurethane-based resin as long as the effects of the present invention are not impaired. The polyurethane-based resin is preferably a polyurethane-based resin obtained from a composition containing polyol (A) and a polyfunctional isocyanate compound (B), or a polyurethane-based resin obtained from a composition containing a urethane prepolymer (C). When such polyurethane-based resin is adopted as the polyurethane-based resin, the surface protective film of the present invention can allow the contamination of an adherend to be additionally suppressed, and can be preferably more excellent in wettability and reworkability.

<Polyurethane-Based Resin Obtained from Composition Containing Polyol (A) and Polyfunctional Isocyanate Compound (B)>

Specifically, the polyurethane-based resin obtained from the composition containing the polyol (A) and the polyfunctional isocyanate compound (B) is preferably a polyurethane-based resin obtained by curing the composition containing the polyol (A) and the polyfunctional isocyanate compound (B). Only one kind of the polyol (A) may be used, or two or more kinds thereof may be used. Only one kind of the polyfunctional isocyanate compound (B) may be used, or two or more kinds thereof may be used.

As the polyol (A), there are given, for example, a polyester polyol, a polyether polyol, a polycaprolactone polyol, a polycarbonate polyol, and a castor oil-based polyol.

The polyester polyol can be obtained by, for example, an esterification reaction between a polyol component and an acid component.

Examples of the polyol component include ethylene glycol, diethylene glycol, 1,3-butanediol, 1,4-butanediol, neopentyl glycol, 3-methyl-1,5-pentanediol, 2-butyl-2-ethyl-1,3-propanediol, 2,4-diethyl-1,5-pentanediol, 1,2-hexanediol, 1,6-hexanediol, 1,8-octanediol, 1,9-nonanediol, 2-methyl-1,8-octanediol, 1,8-decanediol, octadecanediol, glycerin, trimethylolpropane, pentaerythritol, hexanetriol, and polypropylene glycol. Examples of the acid component include succinic acid, methylsuccinic acid, adipic acid, pimelic acid, azelaic acid, sebacic acid, 1,12-dodecanedioic acid, 1,14-tetradecanedioic acid, dimer acid, 2-methyl-1,4-cyclohexanedicarboxylic acid, 2-ethyl-1,4-cyclohexanedicarboxylic acid, terephthalic acid, isophthalic acid, phthalic acid, 1,4-naphthalenedicarboxylic acid, 4,4′-biphenyldicarboxylic acid, and acid anhydrides thereof.

An example of the polyether polyol is a polyether polyol obtained by subjecting an alkylene oxide such as ethylene oxide, propylene oxide, or butylene oxide to addition polymerization through the use of an initiator such as water, a low-molecular-weight polyol (such as propylene glycol, ethylene glycol, glycerin, trimethylolpropane, or pentaerythritol), a bisphenol (such as bisphenol A), or dihydroxybenzene (such as catechol, resorcin, or hydroquinone). Specific examples thereof include polyethylene glycol, polypropylene glycol, and polytetramethylene glycol.

An example of the polycaprolactone polyol is a caprolactone-based polyester diol obtained by subjecting a cyclic ester monomer such as ε-caprolactone or σ-valerolactone to ring-opening polymerization.

Examples of the polycarbonate polyol include: a polycarbonate polyol obtained by subjecting the polyol component and phosgene to a polycondensation reaction; a polycarbonate polyol obtained by subjecting the polyol component and a carbonic acid diester such as dimethyl carbonate, diethyl carbonate, dipropyl carbonate, diisopropyl carbonate, dibutyl carbonate, ethylbutyl carbonate, ethylene carbonate, propylene carbonate, diphenyl carbonate, or dibenzyl carbonate to transesterification and condensation; a copolymerized polycarbonate polyol obtained by using two or more kinds of the polyol components in combination; a polycarbonate polyol obtained by subjecting each of the various polycarbonate polyols and a carboxyl group-containing compound to an esterification reaction; a polycarbonate polyol obtained by subjecting each of the various polycarbonate polyols and a hydroxyl group-containing compound to an etherification reaction; a polycarbonate polyol obtained by subjecting each of the various polycarbonate polyols and an ester compound to a transesterification reaction; a polycarbonate polyol obtained by subjecting each of the various polycarbonate polyols and a hydroxyl group-containing compound to a transesterification reaction; a polyester-type polycarbonate polyol obtained by subjecting each of the various polycarbonate polyols and a dicarboxylic acid compound to a polycondensation reaction; and a copolymerized polyether-type polycarbonate polyol obtained by subjecting each of the various polycarbonate polyols and an alkylene oxide to copolymerization.

An example of the castor oil-based polyol is a castor oil-based polyol obtained by allowing a castor oil fatty acid and the polyol component to react with each other. A specific example thereof is a castor oil-based polyol obtained by allowing a castor oil fatty acid and polypropylene glycol to react with each other.

The polyol (A) preferably contains a polyol (A1) having 3 OH groups and a number-average molecular weight Mn of 8,000 to 20,000. The number of kinds of the polyols (A1) may be only one, or may be two or more.

The content of the polyol (A1) in the polyol (A) is preferably 70 wt % or more, more preferably 70 wt % to 100 wt %, still more preferably 70 wt % to 90 wt %. When the content of the polyol (A1) in the polyol (A) is adjusted within the range, the surface protective film of the present invention can allow the contamination of an adherend to be additionally suppressed, and can be preferably more excellent in wettability and reworkability.

The polyol (A1) has a number-average molecular weight Mn of 8,000 to 20,000, preferably 8,000 to 18,000, more preferably 8,500 to 17,000, still more preferably 9,000 to 16,000, particularly preferably 9,500 to 15,500, most preferably 10,000 to 15,000. When the number-average molecular weight Mn of the polyol (A1) is adjusted within the range, the surface protective film of the present invention can allow the contamination of an adherend to be additionally suppressed, and can be preferably more excellent in wettability and reworkability.

The polyol (A) may contain a polyol (A2) having 3 or more OH groups and a number-average molecular weight Mn of 5,000 or less. The number of kinds of the polyols (A2) may be only one, or may be two or more. The number-average molecular weight Mn of the polyol (A2) is preferably 500 to 5,000, more preferably 800 to 4,500, still more preferably 1,000 to 4,000, particularly preferably 1,000 to 3,500, most preferably 1,000 to 3,000. When the number-average molecular weight Mn of the polyol (A2) deviates from the range, in particular, the degree to which a pressure-sensitive adhesive strength rises with time may become high and hence it may become impossible to express excellent reworkability. The polyol (A2) is preferably a polyol having 3 OH groups (triol), a polyol having 4 OH groups (tetraol), a polyol having 5 OH groups (pentaol), or a polyol having 6 OH groups (hexaol).

The total amount of at least one kind of the polyol having 4 OH groups (tetraol), the polyol having 5 OH groups (pentaol), and the polyol having 6 OH groups (hexaol) as the polyol (A2) is preferably 10 wt % or less, more preferably 7 wt % or less, still more preferably 6 wt % or less, particularly preferably 5 wt % or less in terms of a content in the polyol (A). A urethane-based pressure-sensitive adhesive additionally excellent in transparency can be provided by adjusting the total amount of at least one kind of the polyol having 4 OH groups (tetraol), the polyol having 5 OH groups (pentaol), and the polyol having 6 OH groups (hexaol) as the polyol (A2) in the polyol (A) within the range.

The content of the polyol (A2) in the polyol (A) is preferably 30 wt % or less, more preferably 0 wt % to 30 wt %. When the content of the polyol (A2) in the polyol (A) is adjusted within the range, the surface protective film of the present invention can allow the contamination of an adherend to be additionally suppressed, and can be preferably more excellent in wettability and reworkability.

The content of a polyol having 4 or more OH groups and a number-average molecular weight Mn of 5,000 or less in the polyol (A2) is preferably less than 10 wt %, more preferably 8 wt % or less, still more preferably 7 wt % or less, particularly preferably 6 wt % or less, most preferably 5 wt % or less with respect to the entirety of the polyol (A). When the content of the polyol having 4 or more OH groups and a number-average molecular weight Mn of 5,000 or less in the polyol (A2) is 10 wt % or more with respect to the entirety of the polyol (A), the urethane-based pressure-sensitive adhesive becomes liable to whiten and hence its transparency may reduce.

The number of kinds of the polyfunctional isocyanate compounds (B) may be only one, or may be two or more.

Any appropriate polyfunctional isocyanate compound that may be used in a urethane-forming reaction may be adopted as the polyfunctional isocyanate compound (B). Examples of such polyfunctional isocyanate compound (B) include a polyfunctional aliphatic isocyanate compound, a polyfunctional alicyclic isocyanate compound, and a polyfunctional aromatic isocyanate compound.

Examples of the polyfunctional aliphatic isocyanate compound include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate.

Examples of the polyfunctional alicyclic isocyanate compound include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate.

Examples of the polyfunctional aromatic diisocyanate compound include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

Other examples of the polyfunctional isocyanate compound (B) include trimethylolpropane adducts of the various polyfunctional isocyanate compounds as described above, biurets thereof obtained through their reactions with water, and trimers thereof each having an isocyanurate ring. In addition, they may be used in combination.

Specifically, the polyurethane-based resin is preferably obtained by curing a composition containing the polyol (A) and the polyfunctional isocyanate compound (B). Such composition may contain any appropriate other component in addition to the polyol (A) and the polyfunctional isocyanate compound (B) as long as the effects of the present invention are not impaired. Examples of such other component include a catalyst, a resin component other than the polyurethane-based resin, a tackifier, an inorganic filler, an organic filler, metal powder, a pigment, a foil-shaped material, a softener, a plasticizer, an age resistor, a conductive agent, an antioxidant, a UV absorbing agent, alight stabilizer, a surface lubricating agent, a leveling agent, a corrosion inhibitor, a heat stabilizer, a polymerization inhibitor, a lubricant, and a solvent.

The polyurethane-based resin preferably contains a leveling agent in order that the effects of the present invention maybe additionally expressed. The number of kinds of the leveling agents may be only one, or may be two or more.

The content of the leveling agent is preferably 0.001 wt % to 1 wt %, more preferably 0.002 wt % to 0.5 wt %, still more preferably 0.003 wt % to 0.1 wt %, particularly preferably 0.004 wt % to 0.05 wt %, most preferably 0.005 wt % to 0.01 wt % with respect to the polyol (A). Adjusting the content of the leveling agent within the range allows the surface protective film of the present invention to contaminate an adherend to an additionally low extent, and to be preferably additionally excellent in wettability and reworkability.

Any appropriate leveling agent can be adopted as the leveling agent as long as the effects of the present invention are not impaired. Examples of such leveling agent include an acrylic leveling agent, a fluorine-based leveling agent, and a silicone-based leveling agent. Examples of the acrylic leveling agent include POLYFLOW No. 36, POLYFLOW No. 56, POLYFLOW No. 85HF, and POLYFLOW No. 99C (all of which are manufactured by Kyoeisha Chemical Co., Ltd.). Examples of the fluorine-based leveling agent include MEGAFAC F470N and MEGAFAC F556 (all of which are manufactured by DIC Corporation). An example of the silicone-based leveling agent is GRANDIC PC4100 (manufactured by DIC Corporation).

The polyurethane-based resin preferably contains a deterioration-preventing agent such as an antioxidant, a UV absorbing agent, or a light stabilizer. When the polyurethane-based resin contains the deterioration-preventing agent, the pressure-sensitive adhesive can be excellent in adhesive residue-preventing property. Specifically, even when the pressure-sensitive adhesive is stored in a warmed state after having been attached to an adherend, an adhesive residue hardly occurs on the adherend. Therefore, the surface protective film of the present invention can allow the contamination of the adherend to be additionally suppressed. The number of kinds of the deterioration-preventing agents may be only one, or may be two or more. The deterioration-preventing agent is particularly preferably an antioxidant.

The content of the deterioration-preventing agent is preferably 0.01 wt % to 10 wt %, more preferably 0.05 wt % to 7 wt %, still more preferably 0.1 wt % to 5 wt %, particularly preferably 0.1 wt % to 3 wt %, most preferably 0.1 wt % to 1 wt % with respect to the polyol (A). Adjusting the content of the deterioration-preventing agent within the range can make the pressure-sensitive adhesive additionally excellent in adhesive residue-preventing property. Specifically, even when the pressure-sensitive adhesive is stored in a warmed state after having been attached to an adherend, an adhesive residue occurs on the adherend in an additionally hard manner. Therefore, the surface protective film of the present invention can allow the contamination of the adherend to be additionally suppressed. When the content of the deterioration-preventing agent is excessively small, it may become impossible to express the adhesive residue-preventing property sufficiently. When the content of the deterioration-preventing agent is excessively large, the following problems may arise: a disadvantage in terms of cost appears, pressure-sensitive adhesive characteristics cannot be maintained, or the adherend is contaminated.

Examples of the antioxidant include a radical chain inhibitor and a peroxide decomposer.

Examples of the radical chain inhibitor include a phenol-based antioxidant and an amine-based antioxidant.

Examples of the peroxide decomposer include a sulfur-based antioxidant and a phosphorus-based antioxidant.

Examples of the phenol-based antioxidant include a monophenol-based antioxidant, a bisphenol-based antioxidant, and a high-molecular-weight phenol-based antioxidant.

Examples of the monophenol-based antioxidant include 2,6-di-t-butyl-p-cresol, butylated hydroxyanisole, 2,6-di-t-butyl-4-ethylphenol, and stearin-β-(3,5-di-t-butyl-4-hydroxyphenyl)propionate.

Examples of the bisphenol-based antioxidant include 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), and 3,9-bis[1,1-dimethyl-2-[β-(3-t-butyl-4-hydroxy-5-methylphenyl) propionyloxy]ethyl]2,4,8,10-tetraoxaspiro[5.5]undecane.

Examples of the high-molecular-weight phenol-based antioxidant include 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis-(4′-hydroxy-3′-t-butylphenyl)butyric acid]glycol ester, 1,3,5-tris(3′,5′-di-t-butyl-4′-hydroxybenzyl)-S-triazine-2,4,6-(1H,3H,5H)trione, and tocophenol.

Examples of the sulfur-based antioxidant include dilauryl 3,3′-thiodipropionate, dimyristyl 3,3′-thiodipropionate, and distearyl 3,3′-thiodipropionate.

Examples of the phosphorus-based antioxidant include triphenyl phosphite, diphenyl isodecyl phosphite, and phenyl diisodecyl phosphite.

Examples of the UV absorbing agent include a benzophenone-based UV absorbing agent, a benzotriazole-based UV absorbing agent, a salicylic acid-based UV absorbing agent, an oxalic anilide-based UV absorbing agent, a cyanoacrylate-based UV absorbing agent, and a triazine-based UV absorbing agent.

Examples of the benzophenone-based UV absorbing agent include 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-dimethoxybenzophenone, 2,2′-dihydroxy-4,4′-dimethoxybenzophenone, 2-hydroxy-4-methoxy-5-sulfobenzophenone, and bis(2-methoxy-4-hydroxy-5-benzoylphenyl)methane.

Examples of the benzotriazole-based UV absorbing agent include 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-3′-tert-butyl-5′-methylphenyl)-5-chlorobenzotriazole, 2-(2′-hydroxy-3′,5′-di-tert-butylphenyl)5-chlorobenzotriazole, 2-(2′-hydroxy-3′,5′-di-tert-amylphenyl)benzotriazole, 2-(2′-hydroxy-4′-octoxyphenyl)benzotriazole, 2-[2′-hydroxy-3′-(3″,4″,5″,6″-tetrahydrophthalimidomethyl)-5′-methylphenyl]benzotriazole, 2,2′-methylenebis[4-(1,1,3,3-tetramethylbutyl)-6-(2H-benzotriazole-2-yl)phenol], and 2-(2′-hydroxy-5′-methacryloxyphenyl)-2H-benzotriazole.

Examples of the salicylic acid-based UV absorbing agent include phenyl salicylate, p-tert-butylphenyl salicylate, and p-octylphenyl salicylate.

Examples of the cyanoacrylate-based UV absorbing agent include 2-ethylhexyl-2-cyano-3,3′-diphenyl acrylate, and ethyl-2-cyano-3,3′-diphenyl acrylate.

Examples of the light stabilizer include a hindered amine-based light stabilizer and a UV stabilizer.

Examples of the hindered amine-based light stabilizer may include bis(2,2,6,6-tetramethyl-4-piperidyl) sebacate, bis(1,2,2,6,6-pentamethyl-4-piperidyl) sebacate, and methyl 1,2,2,6,6-pentamethyl-4-piperidyl sebacate.

Examples of the UV stabilizer include nickel bis(octylphenyl)sulfide, [2,2′-thiobis(4-tert-octylphenolate)]-n-butylaminenickel, nickel complex-3,5-di-tert-butyl-4-hydroxybenzyl-phosphoric acid monoethylate, a benzoate-type quencher, and nickel dibutyldithiocarbamate.

The polyurethane-based resin preferably contains a fatty acid ester. When the polyurethane-based resin contains the fatty acid ester, the wetting rate of the pressure-sensitive adhesive can additionally increase. The number of kinds of the fatty acid esters may be only one, or may be two or more.

The content of the fatty acid ester is preferably 5 wt % to 50 wt %, more preferably 7 wt % to 40 wt %, still more preferably 8 wt % to 35 wt %, particularly preferably 9 wt % to 30 wt %, most preferably 10 wt % to 20 wt % with respect to the polyol (A). Adjusting the content of the fatty acid ester within the range can additionally increase the wetting rate. When the content of the fatty acid ester is excessively small, it may be impossible to increase the wetting rate sufficiently. When the content of the fatty acid ester is excessively large, the following problems may arise: a disadvantage in terms of cost appears, pressure-sensitive adhesive characteristics cannot be maintained, or an adherend is contaminated.

The fatty acid ester has a number-average molecular weight Mn of preferably 200 to 400, more preferably 210 to 395, still more preferably 230 to 380, particularly preferably 240 to 360, most preferably 270 to 340. Adjusting the number-average molecular weight Mn of the fatty acid ester within the range can additionally increase the wetting rate. In the case where the number-average molecular weight Mn of the fatty acid ester is excessively small, the wetting rate may not increase even when the number of parts of the ester to be added is large. When the number-average molecular weight Mn of the fatty acid ester is excessively large, the curability of the pressure-sensitive adhesive at the time of its drying may deteriorate to adversely affect not only its wetting characteristic but also other pressure-sensitive adhesive characteristics.

Any appropriate fatty acid ester may be adopted as the fatty acid ester as long as the effects of the present invention are not impaired. Examples of such fatty acid ester include a polyoxyethylene bisphenol A lauric acid ester, butyl stearate, 2-ethylhexyl palmitate, 2-ethylhexyl stearate, behenic acid monoglyceride, cetyl 2-ethylhexanoate, isopropyl myristate, isopropyl palmitate, cholesteryl isostearate, lauryl methacrylate, a coconut fatty acid methyl ester, methyl laurate, methyl oleate, methyl stearate, myristyl myristate, octyldodecyl myristate, pentaerythritol monoleate, pentaerythritol monostearate, pentaerythritol tetrapalmitate, stearyl stearate, isotridecyl stearate, 2-ethylhexanoic acid triglyceride, butyl laurate, and octyl oleate.

The polyurethane-based resin preferably contains a compound that undergoes keto-enol tautomerization. The keto-enol tautomerization refers to, as is generally well known, isomerization in which a hydrogen atom bonded to an α-carbon atom of a carbonyl compound is transferred to the oxygen atom of a carbonyl group, the isomerization being also known as the so-called enolization. By virtue of the fact that the polyurethane-based resin contains the compound that undergoes keto-enol tautomerization, through an interaction with the catalyst, a pot life in a stage where the composition to be used for forming the polyurethane-based resin is stored can be sufficiently lengthened, while, upon formation of the polyurethane-based resin through the use (preferably curing) of the composition, a cross-linking reaction between the polyol (A) and the polyfunctional isocyanate compound (B) rapidly progresses.

Examples of the compound that undergoes keto-enol tautomerization include: β-diketones such as acetylacetone, hexane-2,4-dione, heptane-2,4-dione, heptane-3,5-dione, 5-methylhexane-2,4-dione, octane-2,4-dione, 6-methylheptane-2,4-dione, 2,6-dimethylheptane-3,5-dione, nonane-2,4-dione, nonane-4,6-dione, 2,2,6,6-tetramethylheptane-3,5-dione, tridecane-6,8-dione, 1-phenylbutane-1,3-dione, hexafluoroacetylacetone, and ascorbic acid; β-keto esters such as methyl acetoacetate, ethyl acetoacetate, n-propyl acetoacetate, isopropyl acetoacetate, n-butyl acetoacetate, sec-butyl acetoacetate, tert-butyl acetoacetate, methyl propionylacetate, ethyl propionylacetate, n-propyl propionylacetate, isopropyl propionylacetate, n-butyl propionylacetate, sec-butyl propionylacetate, tert-butyl propionylacetate, benzyl acetoacetate, dimethyl malonate, and diethyl malonate; acid anhydrides such as acetic anhydride; and ketones such as acetone, methyl ethyl ketone, methyl n-butylketone, methyl isobutyl ketone, methyl tert-butyl ketone, methyl phenyl ketone, and cyclohexanone.

The compound that undergoes keto-enol tautomerization is preferably a β-diketone, more preferably acetylacetone. When such compound is adopted as the compound that undergoes keto-enol tautomerization, a pot life in a stage where the composition to be used for forming the polyurethane-based resin is stored through an interaction with the catalyst, can be still more sufficiently lengthened, while a cross-linking reaction between the polyol (A) and the polyfunctional isocyanate compound (B) still more rapidly progresses upon formation of the polyurethane-based resin through the use (preferably curing) of the composition.

A content ratio “compound that undergoes keto-enol tautomerization/catalyst” of the compound that undergoes keto-enol tautomerization to the catalyst is preferably 0.006 to 300, more preferably 0.007 to 100, still more preferably 0.008 to 20, still more preferably 0.009 to 1.1, still more preferably 0.010 to 1.0, still more preferably 0.010 to 0.9, particularly preferably 0.010 to 0.8, most preferably 0.010 to 0.7 in terms of a molar ratio. When the content ratio of the compound that undergoes keto-enol tautomerization to the catalyst is adjusted within the range, through an interaction with the catalyst, a pot life in a stage where the composition to be used for forming the polyurethane-based resin is stored can be still more sufficiently lengthened, while a cross-linking reaction between the polyol (A) and the polyfunctional isocyanate compound (B) still more rapidly progresses upon formation of the polyurethane-based resin through the use (preferably curing) of the composition. In addition, particularly when the molar ratio “compound that undergoes keto-enol tautomerization/catalyst” falls within the range of 0.006 to 0.7, in the surface protective film of the present invention, whitening can be effectively suppressed and very high transparency can be imparted.

The composition containing the polyol (A) and the polyfunctional isocyanate compound (B) preferably contains any appropriate solvent.

The content of the polyfunctional isocyanate compound (B) is preferably 5 wt % to 60 wt %, more preferably 8 wt % to 60 wt %, still more preferably 10 wt % to 60 wt % with respect to the polyol (A). When the content of the polyfunctional isocyanate compound (B) is adjusted within the range, the surface protective film of the present invention can allow the contamination of an adherend to be additionally suppressed, and can be preferably more excellent in wettability and reworkability.

An equivalent ratio “NCO group/OH group” between NCO groups and OH groups in the polyol (A) and the polyfunctional isocyanate compound (B) is preferably 1.0 to 5.0, more preferably 1.2 to 4.0, still more preferably 1.5 to 3.5, particularly preferably 1.8 to 3.0. When the equivalent ratio “NCO group/OH group” is adjusted within the range, the surface protective film of the present invention can allow the contamination of an adherend to be additionally suppressed, and can be preferably more excellent in wettability and reworkability.

Any appropriate method such as a urethane-forming reaction method involving using bulk polymerization, solution polymerization, or the like may be adopted as a method of obtaining the polyurethane-based resin by curing the composition containing the polyol (A) and the polyfunctional isocyanate compound (B) as long as the effects of the present invention are not impaired.

In order to cure the composition containing the polyol (A) and the polyfunctional isocyanate compound (B), a catalyst is preferably used. Examples of such catalyst include an organometallic compound and a tertiary amine compound.

Examples of the organometallic compound may include an iron-based compound, a tin-based compound, a titanium-based compound, a zirconium-based compound, a lead-based compound, a cobalt-based compound, and a zinc-based compound. Of those, an iron-based compound and a tin-based compound are preferred from the viewpoints of a reaction rate and the pot life of the pressure-sensitive adhesive layer.

Examples of the iron-based compound include iron acetylacetonate and iron 2-ethylhexanoate.

Examples of the tin-based compound include dibutyltin dichloride, dibutyltin oxide, dibutyltin dibromide, dibutyltin maleate, dibutyltin dilaurate, dibutyltin diacetate, dibutyltin sulfide, tributyltin methoxide, tributyltin acetate, triethyltin ethoxide, tributyltin ethoxide, dioctyltin oxide, dioctyltin dilaurate, tributyltin chloride, tributyltin trichloroacetate, and tin 2-ethylhexanoate.

Examples of the titanium-based compound include dibutyltitanium dichloride, tetrabutyl titanate, and butoxytitanium trichloride.

Examples of the zirconium-based compound include zirconium naphthenate and zirconium acetylacetonate.

Examples of the lead-based compound include lead oleate, lead 2-ethylhexanoate, lead benzoate, and lead naphthenate.

Examples of the cobalt-based compound include cobalt 2-ethylhexanoate and cobalt benzoate.

Examples of the zinc-based compound include zinc naphthenate and zinc 2-ethylhexanoate.

Examples of the tertiary amine compound include triethylamine, triethylenediamine, and 1,8-diazabicyclo[5.4.0]undec-7-ene.

The number of kinds of the catalysts may be only one, or may be two or more. In addition, the catalyst may be used in combination with a cross-linking retardant or the like. The amount of the catalyst is preferably 0.02 wt % to 0.10 wt %, more preferably 0.02 wt % to 0.08 wt %, still more preferably 0.02 wt % to 0.06 wt %, particularly preferably 0.02 wt % to 0.05 wt % with respect to the polyol (A). When the amount of the catalyst is adjusted within the range, the surface protective film of the present invention can allow the contamination of an adherend to be additionally suppressed, and can be preferably more excellent in wettability and reworkability.

<Polyurethane-Based Resin Obtained from Composition Containing Urethane Prepolymer (C)>

Any appropriate polyurethane-based resin may be adopted as the polyurethane-based resin obtained from the composition containing the urethane prepolymer (C) as long as the polyurethane-based resin is obtained by using the so-called “urethane prepolymer” as a raw material.

The polyurethane-based resin obtained from the composition containing the urethane prepolymer (C) is, for example, a polyurethane-based resin obtained from the composition containing a polyurethane polyol as the urethane prepolymer (C) and the polyfunctional isocyanate compound (B). The number of kinds of the urethane prepolymers (C) may be only one, or may be two or more. The number of kinds of the polyfunctional isocyanate compounds (B) may be only one, or may be two or more.

The polyurethane polyol as the urethane prepolymer (C) is preferably a compound obtained by causing a polyester polyol (a1) and a polyether polyol (a2) to react with an organic polyisocyanate compound (a3) in the presence or absence of the catalyst.

Any appropriate polyester polyol can be used as the polyester polyol (a1). An example of the polyester polyol (a1) is a polyester polyol obtained by causing an acid component and a glycol component to react with each other. As the acid component, there are given, for example, terephthalic acid, adipic acid, azelaic acid, sebacic acid, phthalic anhydride, isophthalic acid, and trimellitic acid. As the glycol component, there are given, for example, ethylene glycol, propylene glycol, diethylene glycol, butylene glycol, 1,6-hexane glycol, 3-methyl-1,5-pentanediol, 3,3′-dimethylolheptane, polyoxyethylene glycol, polyoxypropylene glycol, 1,4-butanediol, neopentyl glycol, and butylethylpentanediol. As a polyol component, there are given, for example, glycerin, trimethylolpropane, and pentaerythritol. Another example of the polyester polyol (a1) is a polyester polyol obtained by subjecting a lactone such as polycaprolactone, poly(β-methyl-γ-valerolactone), or polyvalerolactone to ring-opening polymerization.

With regard to the molecular weight of the polyester polyol (a1), polyester polyol having any molecular weight ranging from a low molecular weight to a high molecular weight may be used. The molecular weight of the polyester polyol (a1) is preferably 500 to 5,000 in terms of number-average molecular weight. When the number-average molecular weight is less than 500, the polyester polyol (a1) may have high reactivity and may be liable to cause gelation. When the number-average molecular weight is more than 5,000, the polyester polyol (a1) may have low reactivity, and further, the cohesive strength of the polyurethane polyol itself may reduce. The use amount of the polyester polyol (a1) is preferably 10 to 90 mol % in the polyol constituting the polyurethane polyol.

Any appropriate polyether polyol can be used as the polyether polyol (a2). An example of the polyether polyol (a2) is polyether polyol obtained by polymerizing an oxirane compound, e.g., ethylene oxide, propylene oxide, butylene oxide, or tetrahydrofuran using water, or a low-molecular-weight polyol such as propylene glycol, ethylene glycol, glycerin, or trimethylolpropane as an initiator. A specific example of such polyether polyol (a2) is polyether polyol having a functional group number of two or more such as polypropylene glycol, polyethylene glycol, or polytetramethylene glycol.

With regard to the molecular weight of the polyether polyol (a2), polyether polyol having any molecular weight ranging from a low molecular weight to a high molecular weight may be used. The molecular weight of the polyether polyol (a2) is preferably 1,000 to 5,000 in terms of number-average molecular weight. When the number-average molecular weight is less than 1,000, the polyether polyol (a2) may have high reactivity and may be liable to cause gelation. When the number-average molecular weight is more than 5,000, the polyether polyol (a2) may have low reactivity, and further, the cohesive strength of the polyurethane polyol itself may reduce. The use amount of the polyether polyol (a2) is preferably 20 to 80 mol % in the polyol constituting the polyurethane polyol.

It is also possible to use the polyether polyol (a2) whose part has been substituted with a glycol such as ethylene glycol, 1,4-butanediol, neopentyl glycol, butylethylpentanediol, glycerin, trimethylolpropane, or pentaerythritol, or with a polyvalent amine such as ethylenediamine, N-aminoethylethanolamine, isophoronediamine, or xylylenediamine as required.

Only bifunctional polyether polyol may be used as the polyether polyol (a2), or polyether polyol having a number-average molecular weight of 1,000 to 5,000 and having at least 3 hydroxyl groups per molecule may be used as part or all of the polyether polyol (a2). When polyether polyol having an average molecular weight of 1,000 to 5,000 and having at least 3 hydroxyl groups per molecule is used as part or all of the polyether polyol (a2), a balance between pressure-sensitive adhesive strength and re-peelability can become satisfactory. When such polyether polyol has a number-average molecular weight of less than 1,000, the polyether polyol may have high reactivity and may be liable to cause gelation. In addition, when such polyether polyol has a number-average molecular weight of more than 5,000, the polyether polyol may have low reactivity, and further, the cohesive strength of the polyurethane polyol itself may reduce. The number-average molecular weight of such polyether polyol is more preferably 2,500 to 3,500.

Any appropriate organic polyisocyanate compound may be used as the organic polyisocyanate compound (a3). Examples of such organic polyisocyanate compound (a3) include aromatic polyisocyanate, aliphatic polyisocyanate, aromatic/aliphatic polyisocyanate, and alicyclic polyisocyanate.

Examples of the aromatic polyisocyanate include 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, 2,4,6-triisocyanatotoluene, 1,3,5-triisocyanatobenzene, dianisidine diisocyanate, 4,4′-diphenyl ether diisocyanate, and 4,4′,4″-triphenylmethane triisocyanate.

Examples of the aliphatic polyisocyanate include trimethylene diisocyanate, tetramethylene diisocyanate, hexamethylene diisocyanate, pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate.

Examples of the aromatic/aliphatic polyisocyanate include ω,ω′-diisocyanato-1,3-dimethylbenzene, ω,ω′-diisocyanato-1,4-dimethylbenzene, ω,ω′-diisocyanato-1,4-diethylbenzene, 1,4-tetramethylxylylene diisocyanate, and 1,3-tetramethylxylylene diisocyanate.

Examples of the alicyclic polyisocyanate include 3-isocyanatomethyl-3,5,5-trimethylcyclohexyl isocyanate, 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylenebis(cyclohexyl isocyanate), 1,4-bis(isocyanatomethyl)cyclohexane, and 1,4-bis(isocyanatomethyl)cyclohexane.

It is also possible to use, for example, a trimethylolpropane adduct, a biuret obtained through a reaction with water, or a trimer having an isocyanurate ring as the organic polyisocyanate compound (a3).

Any appropriate catalyst may be used as the catalyst that may be used in obtaining the polyurethane polyol. Examples of the catalyst include a tertiary amine-based compound and an organometallic compound.

Examples of the tertiary amine-based compound include triethylamine, triethylenediamine, and 1,8-diazabicyclo[5.4.0]-undec-7-ene (DBU).

Examples of the organometallic compound include a tin-based compound and a non-tin-based compound.

Examples of the tin-based compound include dibutyltin dichloride, dibutyltin oxide, dibutyltin dibromide, dibutyltin dimaleate, dibutyltin dilaurate (DBTDL), dibutyltin diacetate, dibutyltin sulfide, tributyltin sulfide, tributyltin oxide, tributyltin acetate, triethyltin ethoxide, tributyltin ethoxide, dioctyltin oxide, tributyltin chloride, tributyltin trichloroacetate, and tin 2-ethylhexanonate.

Examples of the non-tin-based compound include: titanium-based compounds such as dibutyltitanium dichloride, tetrabutyl titanate, and butoxytitanium trichloride; lead-based compounds such as lead oleate, lead 2-ethylhexanonate, lead benzoate, and lead naphthenate; iron-based compounds such as iron 2-ethylhexanonate and iron acetylacetonate; cobalt-based compounds such as cobalt benzoate and cobalt 2-ethylhexanoate; zinc-based compounds such as zinc naphthenate and zinc 2-ethylhexanoate; and zirconium-based compounds such as zirconium naphthenate.

When only a single catalyst is used for obtaining the polyurethane polyol in a system in which two kinds of polyol, i.e., polyester polyol and polyether polyol are present, the following problems are liable to occur owing to their difference in reactivity. That is, gelation may occur and the reaction solution may become turbid. Thus, the use of two kinds of catalysts for obtaining the polyurethane polyol allows the reaction rate, catalyst selectivity, and the like to be easily controlled, and thus can solve those problems. A combination of such two kinds of catalysts is exemplified by combinations of a tertiary amine/an organic metal-based catalyst, a tin-based catalyst/a non-tin-based catalyst, and a tin-based catalyst/a tin-based catalyst. Of those, a combination of a tin-based catalyst/a tin-based catalyst is preferred, and a combination of dibutyltin dilaurate and tin 2-ethylhexanoate is more preferred. Their compounding ratio “tin 2-ethylhexanoate/dibutyltin dilaurate” is preferably less than 1, more preferably 0.2 to 0.6 in terms of weight ratio. When the compounding ratio is 1 or more, gelation may be liable to occur on the basis of a balance between catalytic activities.

When the catalyst is used for obtaining the polyurethane polyol, the use amount of the catalyst is preferably 0.01 to 1.0 wt % with respect to the total amount of the polyester polyol (a1), the polyether polyol (a2), and the organic polyisocyanate compound (a3).

When the catalyst is used for obtaining the polyurethane polyol, a reaction temperature is preferably less than 100° C., more preferably 85° C. to 95° C. When the reaction temperature is 100° C. or more, the reaction rate and a cross-linked structure may be difficult to control, and polyurethane polyol having a predetermined molecular weight may be difficult to obtain.

The catalyst may not be used for obtaining the polyurethane polyol. In that case, the reaction temperature is preferably 100° C. or more, more preferably 110° C. or more. In addition, when the polyurethane polyol is obtained in the absence of the catalyst, the reaction is preferably performed for 3 hours or more.

As a method of obtaining the polyurethane polyol, there are given, for example, (1) a method involving loading all amounts of the polyester polyol, the polyether polyol, the catalyst, and the organic polyisocyanate in a flask, and (2) a method involving loading the polyester polyol, the polyether polyol, and the catalyst in a flask, and adding the organic polyisocyanate thereto through dropping. The method of (2) is preferred as a method of obtaining the polyurethane polyol from the viewpoint of control of the reaction.

Upon obtaining the polyurethane polyol, any appropriate solvent may be used. Examples of the solvent include methyl ethyl ketone, ethyl acetate, toluene, xylene, and acetone. Of those solvents, toluene is preferred.

For the polyfunctional isocyanate compound (B), reference may be made to those mentioned above.

The composition containing the urethane prepolymer (C) may contain any appropriate other component as long as the effects of the present invention are not impaired. For such other component, reference may be made to those mentioned above.

Any appropriate production method may be adopted as a method of producing the polyurethane-based resin obtained from the composition containing the urethane prepolymer (C) as long as the method is a method of producing a polyurethane-based resin involving using the so-called “urethane prepolymer” as a raw material.

### <<Base Material Layer>>

Any appropriate thickness may be adopted as the thickness of the base material layer depending on applications. The thickness of the base material layer is preferably 5 μm to 300 μm, more preferably 10 μm to 250 μm, still more preferably 15 μm to 200 μm, particularly preferably 20 μm to 150 μm.

The base material layer may be a single layer, or may be a laminate of two or more layers. The base material layer may be one having been stretched in advance.

Any appropriate material may be adopted as a material for the base material layer depending on applications. Examples of the material include a plastic, paper, a metal film, and a nonwoven fabric. Of those, a plastic is preferred. The materials may be used alone or in combination to construct the base material layer. For example, the layer may be constructed of two or more kinds of plastics.

Examples of the plastic include a polyester-based resin, a polyamide-based resin, and a polyolefin-based resin. Examples of the polyester-based resin include polyethylene terephthalate, polybutylene terephthalate, and polyethylene naphthalate. Examples of the polyolefin-based resin include a homopolymer of an olefin monomer and a copolymer of olefin monomers. Specific examples of the polyolefin-based resin include: homopolypropylene; propylene-based copolymers such as block, random, and graft copolymers each including an ethylene component as a copolymer component; reactor TPO; ethylene-based polymers such as low density, high density, linear low density, and ultra low density polymers; and ethylene-based copolymers such as an ethylene-propylene copolymer, an ethylene-vinyl acetate copolymer, an ethylene-methyl acrylate copolymer, an ethylene-ethyl acrylate copolymer, an ethylene-butyl acrylate copolymer, an ethylene-methacrylic acid copolymer, and an ethylene-methyl methacrylate copolymer.

The base material layer may contain any appropriate additive as required. Examples of the additive that may be contained in the base material layer include an antioxidant, a UV absorbing agent, a light stabilizer, an antistatic agent, a filler, and a pigment. The kinds, number, and amount of the additives that may be contained in the base material layer may be appropriately set depending on purposes. In particular, when the material for the base material layer is a plastic, it is preferred to contain some of the additives for the purpose of, for example, preventing deterioration. From the viewpoint of, for example, the improvement of weather ability, particularly preferred examples of the additive include an antioxidant, a UV absorbing agent, a light stabilizer, and a filler.

Any appropriate antioxidant may be adopted as the antioxidant. Examples of such antioxidant include a phenol-based antioxidant, a phosphorus-based processing heat stabilizer, a lactone-based processing heat stabilizer, a sulfur-based heat stabilizer, and a phenol-phosphorus-based antioxidant. The content of the antioxidant is preferably 1 wt % or less, more preferably 0.5 wt % or less, still more preferably 0.01 wt % to 0.2 wt % with respect to the base resin of the base material layer (when the base material layer is a blend, the blend is the base resin).

Any appropriate UV absorbing agent may be adopted as the UV absorbing agent. Examples of such UV absorbing agent include a benzotriazole-based UV absorbing agent, a triazine-based UV absorbing agent, and a benzophenone-based UV absorbing agent. The content of the UV absorbing agent is preferably 2 wt % or less, more preferably 1 wt % or less, still more preferably 0.01 wt % to 0.5 wt % with respect to the base resin that forms the base material layer (when the base material layer is a blend, the blend is the base resin).

Any appropriate light stabilizer may be adopted as the light stabilizer. Examples of such light stabilizer include a hindered amine-based light stabilizer and a benzoate-based light stabilizer. The content of the light stabilizer is preferably 2 wt % or less, more preferably 1 wt % or less, still more preferably 0.01 wt % to 0.5 wt % with respect to the base resin that forms the base material layer (when the base material layer is a blend, the blend is the base resin).

Any appropriate filler may be adopted as the filler. An example of such filler is an inorganic filler. Specific examples of the inorganic filler include carbon black, titanium oxide, and zinc oxide. The content of the filler is preferably 20 wt % or less, more preferably 10 wt % or less, still more preferably 0.01 wt % to 10 wt % with respect to the base resin that forms the base material layer (when the base material layer is a blend, the blend is the base resin).

Further, a surfactant, an inorganic salt, a polyhydric alcohol, a metal compound, an inorganic antistatic agent such as carbon, and low-molecular-weight and high-molecular-weight antistatic agents each intended to impart antistatic property are also preferably given as examples of the additive. Of those, a high-molecular-weight antistatic agent or carbon is particularly preferred from the viewpoints of contamination and the maintenance of pressure-sensitive adhesiveness.

### <<Method of Manufacturing Surface Protective Film>>

The surface protective film of the present invention may be manufactured by any appropriate method. Such manufacturing method may be performed in conformity with any appropriate manufacturing method such as:

(1) a method involving applying a solution or heat-melt of a material for forming the pressure-sensitive adhesive layer onto the base material layer;
(2) a method in accordance with the method (1) involving applying the solution or heat-melt onto a separator, and transferring the formed pressure-sensitive adhesive layer onto the base material layer;
(3) a method involving extruding a material for forming the pressure-sensitive adhesive layer onto the base material layer, and forming the layer by application;
(4) a method involving extruding the base material layer and the pressure-sensitive adhesive layer in two or more layers;
(5) a method involving laminating the base material layer with a single layer, i.e., the pressure-sensitive adhesive layer or a method involving laminating the base material layer with two layers, i.e., the pressure-sensitive adhesive layer and a laminate layer; or
(6) a method involving forming the pressure-sensitive adhesive layer and a material for forming the base material layer such as a film or a laminate layer into a laminate of two or more layers.

For example, a roll coater method, a comma coater method, a die coater method, a reverse coater method, a silk screen method, or a gravure coater method is available as the application method.

### <<Application of Surface Protective Film>>

The surface protective film of the present invention may be used in any appropriate application. The surface protective film of the present invention preferably allows the contamination of an adherend to be extremely suppressed, and is preferably excellent in wettability and reworkability. Accordingly, the surface protective film of the present invention is preferably used for, for example, protecting a surface of a thin display member, a thin display apparatus, a thin optical film, or an electronic device. An example of the thin display member is a touch panel using an LCD or the like. Examples of the thin display apparatus include an LCD and a color filter to be used therein. An example of the thin optical film is a polarizing plate.

The member to which the surface protective film of the present invention is attached such as a thin display member, a thin display apparatus, a thin optical film, or an electronic device can be manually attached and peeled any number of times.

Hereinafter, the present invention is described specifically by way of Examples. However, the present invention is by no means limited to Examples. It should be noted that test and evaluation methods in Examples and the like are as described below. It should be noted that the term “part(s)” in the following description means “part(s) by weight” unless otherwise specified, and the term “%” in the following description means “wt %” unless otherwise specified.

### <Evaluation for Wetting Rate>

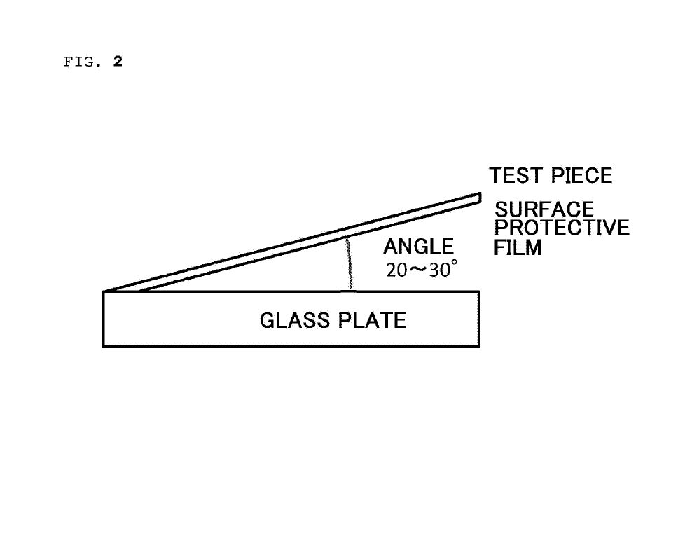

Test piece: a piece obtained by cutting the surface protective film into a size of 2.5 cm×15.0 cm
Adherend: glass plate (manufactured by Matsunami Glass Ind., Ltd., trade name: Micro Slide Glass S)
Number of times of measurement: 3 times (an average value of values independently measured 3 times is adopted)
Measurement environment: clean room of class 10,000 (temperature: 23° C., humidity: 50% RH)
(1) As illustrated in FIG. 2, the pressure-sensitive adhesive layer surface of the test piece, part of which had been brought into contact with the glass plate as the adherend, was held with a hand so as to form an angle of 20° to 30°.
(2) Next, the hand was freed from the test piece, and the manner in which the pressure-sensitive adhesive layer surface of the test piece was wet and spread in one direction from the contact portion at which the surface had been brought into contact with the glass plate was recorded with a video camera. It should be noted that, when a state in which wetting and spreading occurred from a portion except the portion at which the part of the pressure-sensitive adhesive layer surface of the test piece had been brought into contact with the glass plate as the adherend was observed in the section (1), measurement/recording was not performed.
(3) A time period until the entirety of the test piece was wet and spread was recorded, and a wetting rate (cm/sec) was determined by calculation with the following equation: wetting rate (cm/sec)=measurement length (10 cm)/recorded time period in seconds (sec).

### <Evaluation for Initial Pressure-Sensitive Adhesive Strength>

A surface protective film was cut into a size of 25 mm wide by 150 mm long to produce a sample for an evaluation.

Under an atmosphere having a temperature of 23° C. and a humidity of 50% RH, the pressure-sensitive adhesive layer surface of the sample for an evaluation was attached to a glass plate (manufactured by Matsunami Glass Ind., Ltd., trade name: Micro Slide Glass S) by moving a 2.0-kg roller from one end to the other and back. The resultant was aged under an atmosphere having a temperature of 23° C. and a humidity of 50% RH for 30 minutes, and was then measured for its pressure-sensitive adhesive strength by being peeled with a universal tensile tester (manufactured by Minebea Co., Ltd., product name: TCM-1kNB) at a peel angle of 180° and a rate of pulling of 300 mm/min.

<Measurement of Pressure-Sensitive Adhesive Strength with Respect to Glass Plate after Attachment at 50° C. for 10 Days>

A sample for an evaluation was produced by the same method as that in the case of the initial pressure-sensitive adhesive strength with respect to a glass plate, and was measured for its pressure-sensitive adhesive strength after storage at a temperature of 50° C. and a humidity of 50% RH for 10 days by the same method as that in the case of the initial pressure-sensitive adhesive strength.

### <Evaluation for Residual Adhesive Strength>

To the measurement surface side of the glass plate after the measurement of the “pressure-sensitive adhesive strength with respect to a glass plate after attachment at 50° C. for 10 days” was attached a pressure-sensitive adhesive tape “No. 31B” manufactured by NITTO DENKO CORPORATION (base material thickness: 50 μm, total thickness: 80 μm, width: 19 mm) under an atmosphere having a temperature of 23° C. and a humidity of 50% RH by moving a 2.0-kg roller from one end to the other and back. The resultant was aged under an atmosphere having a temperature of 23° C. and a humidity of 50% RH for 30 minutes, and was then measured for its pressure-sensitive adhesive strength by being peeled with a universal tensile tester (manufactured by Minebea Co., Ltd., product name: TCM-1kNB) at a peel angle of 180° and a rate of pulling of 300 mm/min.

### Example 1

75 Parts by weight of PREMINOL 53011 (manufactured by ASAHI GLASS CO., LTD., Mn=10,000), which was polyol having 3 OH groups, and 25 parts by weight of SANNIX GP-1500 (manufactured by Sanyo Chemical Industries, Ltd., Mn=3,000), which was polyol having 3 OH groups, were each used as polyol. The polyol, 10 parts by weight of a fatty acid ester (isopropyl palmitate, manufactured by Kao Corporation, trade name: EXCEPARL IPP, Mn=299), 0.01 part by weight of a leveling agent (POLYFLOW No. 36 (acrylic), manufactured by Kyoeisha Chemical Co., Ltd.), 40 parts by weight of a trimethylolpropane/tolylene diisocyanate trimer adduct (manufactured by Nippon Polyurethane Industry Co., Ltd., trade name: CORONATE L) as a polyfunctional isocyanate compound, 0.08 part by weight of EMBILIZER OL-1 (dioctyltin dilaurate-based catalyst, manufactured by Tokyo Fine Chemical CO., LTD.) as a catalyst, and 0.50 part by weight of Irganox 1010 (manufactured by BASF) as an antioxidant were diluted with toluene so as to provide a pressure-sensitive adhesive composition having a solid content of 80%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 2

85 Parts by weight of PREMINOL 53011 (manufactured by ASAHI GLASS CO., LTD., Mn=10,000), which was polyol having 3 OH groups, 13 parts by weight of SANNIX GP-3000 (manufactured by Sanyo Chemical Industries, Ltd., Mn=3,000), which was polyol having 3 OH groups, and 2 parts by weight of SANNIX GP-1000 (manufactured by Sanyo Chemical Industries, Ltd., Mn=1,000), which was polyol having 3 OH groups, were each used as polyol. The polyol, 0.01 part by weight of a leveling agent (POLYFLOW No. 36 (acrylic), manufactured by Kyoeisha Chemical Co., Ltd.), 18 parts by weight of CORONATE HX that was a polyfunctional alicyclic isocyanate compound (manufactured by Nippon Polyurethane Industry Co., Ltd.) as a polyfunctional isocyanate compound, 0.08 part by weight of EMBILIZER OL-1 (dioctyltin dilaurate-based catalyst, manufactured by Tokyo Fine Chemical CO., LTD.) as a catalyst, and 0.50 part by weight of Irganox 1010 (manufactured by BASF) as an antioxidant were diluted with toluene so as to provide a pressure-sensitive adhesive composition having a solid content of 80%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 3

A pressure-sensitive adhesive layer formed of a urethane-based pressure-sensitive adhesive was produced on the base material in the same manner as in Example 2 except that 10 parts by weight of a fatty acid ester (isopropyl palmitate, manufactured by Kao Corporation, trade name: EXCEPARL IPP, Mn=299) were added as a component of the urethane-based pressure-sensitive adhesive composition.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 4

100 Parts by weight of “CYABINE SH-109H” (solid content: 54%, manufactured by TOYOCHEM CO., LTD.) as a urethane pressure-sensitive adhesive, 9.5 parts by weight of “CYABINE T-501B” (manufactured by TOYOCHEM CO., LTD.) as a cross-linking agent, and 0.01 part by weight of a leveling agent (POLYFLOW No. 36 (acrylic), manufactured by Kyoeisha Chemical Co., Ltd.) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 5

100 Parts by weight of “CYABINE SH-109H” (solid content: 54%, manufactured by TOYOCHEM CO., LTD.) as a urethane pressure-sensitive adhesive, 8.2 parts by weight of CORONATE HX that was a polyfunctional alicyclic isocyanate compound (manufactured by Nippon Polyurethane Industry Co., Ltd.) as a polyfunctional isocyanate compound, and 0.01 part by weight of a leveling agent (POLYFLOW No. 36 (acrylic), manufactured by Kyoeisha Chemical Co., Ltd.) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 6

100 Parts by weight of “CYABINE SH-109H” (solid content: 54%, manufactured by TOYOCHEM CO., LTD.) as a urethane pressure-sensitive adhesive, 15.8 parts by weight of a trimethylolpropanel tolylene diisocyanate trimer adduct (manufactured by Nippon Polyurethane Industry Co., Ltd., trade name: CORONATE L) as a polyfunctional isocyanate compound, and 0.01 part by weight of a leveling agent (POLYFLOW No. 36 (acrylic), manufactured by Kyoeisha Chemical Co., Ltd.) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 7

100 Parts by weight of “CYABINE SH-109H” (solid content: 54%, manufactured by TOYOCHEM CO., LTD.) as a urethane pressure-sensitive adhesive, 6.9 parts by weight of “CYABINE BXX-6269” (manufactured by TOYOCHEM CO., LTD.) as a cross-linking agent, and 0.01 part by weight of a leveling agent (POLYFLOW No. 36 (acrylic), manufactured by Kyoeisha Chemical Co., Ltd.) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 8

100 Parts by weight of “CYABINE SH-109H” (solid content: 54%, manufactured by TOYOCHEM CO., LTD.) as a urethane pressure-sensitive adhesive, 6.9 parts by weight of “CYABINE BXX-6269” (manufactured by TOYOCHEM CO., LTD.) as a cross-linking agent, and 0.05 part by weight of a leveling agent (GRANDIC PC4100 (silicone), manufactured by DIC Corporation) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 9

100 Parts by weight of “CYABINE SH-109H” (solid content: 54%, manufactured by TOYOCHEM CO., LTD.) as a urethane pressure-sensitive adhesive, 6.9 parts by weight of “CYABINE BXX-6269” (manufactured by TOYOCHEM CO., LTD.) as a cross-linking agent, and 0.01 part by weight of a leveling agent (GRANDIC PC4100 (silicone), manufactured by DIC Corporation) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 10

100 Parts by weight of “CYABINE SH-109H” (solid content: 54%, manufactured by TOYOCHEM CO., LTD.) as a urethane pressure-sensitive adhesive, 6.9 parts by weight of “CYABINE BXX-6269” (manufactured by TOYOCHEM CO., LTD.) as a cross-linking agent, and 0.05 part by weight of a leveling agent (MEGAFAC F470N (fluorine), manufactured by DIC Corporation) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Example 11

100 Parts by weight of “CYABINE SH-109H” (solid content: 54%, manufactured by TOYOCHEM CO., LTD.) as a urethane pressure-sensitive adhesive, 6.9 parts by weight of “CYABINE BXX-6269” (manufactured by TOYOCHEM CO., LTD.) as a cross-linking agent, and 0.01 part by weight of a leveling agent (MEGAFAC F470N (fluorine), manufactured by DIC Corporation) were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 1 shows the results of the evaluations.

### Comparative Example 1

100 Parts by weight of “X-40-3344” (solid content: 30%, manufactured by Shin-Etsu Chemical Co., Ltd.) as a silicone pressure-sensitive adhesive, and 2.5 parts by weight of “CAT-PL-50T” (manufactured by Shin-Etsu Chemical Co., Ltd.) as a platinum catalyst were diluted with toluene so as to provide a pressure-sensitive adhesive composition having a solid content of 25%, and the mixture was stirred with a disper to produce a silicone-based pressure-sensitive adhesive composition. The composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 150° C. and a drying time of 5 minutes. Thus, a pressure-sensitive adhesive layer formed of a silicone-based pressure-sensitive adhesive was produced on the base material.

Next, the silicone-treated surface of a base material formed of a polyester resin having a thickness of 25 μm one surface of which had been subjected to a fluorinated silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 2

100 Parts by weight of “X-40-3352-1” (solid content: 30%, manufactured by Shin-Etsu Chemical Co., Ltd.) as a silicone pressure-sensitive adhesive, and 2.5 parts by weight of “CAT-PL-50T” (manufactured by Shin-Etsu Chemical Co., Ltd.) as a platinum catalyst were diluted with toluene so as to provide a pressure-sensitive adhesive composition having a solid content of 25%, and the mixture was stirred with a disper to produce a silicone-based pressure-sensitive adhesive composition. The composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 150° C. and a drying time of 5 minutes. Thus, a pressure-sensitive adhesive layer formed of a silicone-based pressure-sensitive adhesive was produced on the base material.

Next, the silicone-treated surface of a base material formed of a polyester resin having a thickness of 25 μm one surface of which had been subjected to a fluorinated silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 3

75 Parts by weight of PREMINOL 53011 (manufactured by ASAHI GLASS CO., LTD., Mn=10,000), which was polyol having 3 OH groups, and 25 parts by weight of SANNIX GP-1500 (manufactured by Sanyo Chemical Industries, Ltd., Mn=3,000), which was polyol having 3 OH groups, were each used as polyol. The polyol, 10 parts by weight of a fatty acid ester (isopropyl palmitate, manufactured by Kao Corporation, trade name: EXCEPARL IPP, Mn=299), 40 parts by weight of a trimethylolpropane/tolylene diisocyanate trimer adduct (manufactured by Nippon Polyurethane Industry Co., Ltd., trade name: CORONATE L) as a polyfunctional isocyanate compound, 0.08 part by weight of EMBILIZER OL-1 (dioctyltin dilaurate-based catalyst, manufactured by Tokyo Fine Chemical CO., LTD.) as a catalyst, and 0.50 part by weight of Irganox 1010 (manufactured by BASF) as an antioxidant were diluted with toluene so as to provide a pressure-sensitive adhesive composition having a solid content of 80%, and the mixture was stirred with a disper to provide a urethane-based pressure-sensitive adhesive composition. The resultant urethane-based pressure-sensitive adhesive composition was applied onto a base material “T100-755” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 4

85 Parts by weight of PREMINOL 53011 (manufactured by ASAHI GLASS CO., LTD., Mn=10,000), which was polyol having 3 OH groups, 13 parts by weight of SANNIX GP-3000 (manufactured by Sanyo Chemical Industries, Ltd., Mn=3,000), which was polyol having 3 OH groups, and 2 parts by weight of SANNIX GP-1000 (manufactured by Sanyo Chemical Industries, Ltd., Mn=1,000), which was polyol having 3 OH groups, were each used as polyol. The polyol, 18 parts by weight of CORONATE HX that was a polyfunctional alicyclic isocyanate compound (manufactured by Nippon Polyurethane Industry Co., Ltd.) as a polyfunctional isocyanate compound, 0.08 part by weight of EMBILIZER OL-1 (dioctyltin dilaurate-based catalyst, manufactured by Tokyo Fine Chemical CO., LTD.) as a catalyst, and 0.50 part by weight of Irganox 1010 (manufactured by BASF) as an antioxidant were diluted with toluene so as to provide a pressure-sensitive adhesive composition having a solid content of 80%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 5

A pressure-sensitive adhesive layer formed of a urethane-based pressure-sensitive adhesive was produced on a base material in the same manner as in Example 2 except that: no leveling agent was used as a component of the urethane-based pressure-sensitive adhesive composition; and 10 parts by weight of a fatty acid ester (isopropyl palmitate, manufactured by Kao Corporation, trade name: EXCEPARL IPP, Mn=299) were added.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 6

100 Parts by weight of “CYABINE SH-109H” (solid content: 54%, manufactured by TOYOCHEM CO., LTD.) as a urethane pressure-sensitive adhesive, and 9.5 parts by weight of “CYABINE T-501B” (manufactured by TOYOCHEM CO., LTD.) as a cross-linking agent were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 7

100 Parts by weight of “CYABINE SH-109H” (solid content: 54%, manufactured by TOYOCHEM CO., LTD.) as a urethane pressure-sensitive adhesive, and 8.2 parts by weight of CORONATE HX that was a polyfunctional alicyclic isocyanate compound (manufactured by Nippon Polyurethane Industry Co., Ltd.) as a polyfunctional isocyanate compound were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 8

100 Parts by weight of “CYABINE SH-109H” (solid content: 54%, manufactured by TOYOCHEM CO., LTD.) as a urethane pressure-sensitive adhesive, and 15.8 parts by weight of a trimethylolpropane/tolylene diisocyanate trimer adduct (manufactured by Nippon Polyurethane Industry Co., Ltd., trade name: CORONATE L) as a polyfunctional isocyanate compound were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 2 shows the results of the evaluations.

### Comparative Example 9

100 Parts by weight of “CYABINE SH-109H” (solid content: 54%, manufactured by TOYOCHEM CO., LTD.) as a urethane pressure-sensitive adhesive, and 6.9 parts by weight of “CYABINE BXX-6269” (manufactured by TOYOCHEM CO., LTD.) as a cross-linking agent were diluted with toluene so as to provide a pressure-sensitive adhesive composition having a solid content of 45%, and the mixture was stirred with a disper to provide a urethane-based pressure-sensitive adhesive composition. The resultant urethane-based pressure-sensitive adhesive composition was applied onto a base material “T100-75S” formed of a polyester resin (thickness: 75 μm, manufactured by Mitsubishi Plastics, Inc.) with a fountain roll so as to have a thickness after drying of 75 μm, and was cured and dried under the conditions of a drying temperature of 130° C. and a drying time of 3 minutes. Thus, a pressure-sensitive adhesive layer formed of a urethane-based pressure-sensitive adhesive was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film. The resultant surface protective film was aged at normal temperature for 7 days, and was then evaluated.

Table 2 shows the results of the evaluations.

TABLE 1

| | | | | | | Example | Example | Example | Example | Example | Example |
|---|---|---|---|---|---|---|---|---|---|---|---|
| Sample | Example 1 | Example 2 | Example 3 | Example 4 | Example 5 | 6 | 7 | 8 | 9 | 10 | 11 |
| Wetting rate | 1.0 | 2.9 | 3.6 | 3.3 | 5.0 | 1.6 | 4.4 | 4.3 | 4.2 | 4.2 | 4.0 |
| [cm/sec] | | | | | | | | | | | |
| Initial | 0.03 | 0.03 | 0.03 | 0.03 | 0.02 | 0.03 | 0.03 | 0.01 | 0.02 | 0.03 | 0.03 |
| pressure-sensitive | | | | | | | | | | | |
| adhesive strength | | | | | | | | | | | |
| [N/25 mm] | | | | | | | | | | | |
| Pressure-sensitive | 0.04 | 0.05 | 0.04 | 0.07 | 0.03 | 0.13 | 0.08 | 0.03 | 0.04 | 0.10 | 0.08 |
| adhesive | | | | | | | | | | | |
| strength after | | | | | | | | | | | |
| attachment at | | | | | | | | | | | |
| 50° C. for 10 | | | | | | | | | | | |
| days [N/25 mm] | | | | | | | | | | | |
| Residual adhesive | 9.31 | 9.45 | 9.31 | 9.79 | 9.75 | 9.55 | 9.90 | 7.00 | 8.02 | 9.68 | 10.06 |
| strength | | | | | | | | | | | |
| [N/19 mm] | | | | | | | | | | | |

TABLE 2

| | Comparative | Comparative | Comparative | Comparative | Comparative | Comparative | Comparative | Comparative | Comparative |
|---|---|---|---|---|---|---|---|---|---|
| Sample | Example 1 | Example 2 | Example 3 | Example 4 | Example 5 | Example 6 | Example 7 | Example 8 | Example 9 |
| Wetting rate | 5.0 | 2.9 | — *1 | *1 — | *1 — | *1 — | *1 — | *1 — | *1 — |
| [cm/sec] | | | | | | | | | |
| Initial | 0.02 | 0.01 | — *2 | *2 — | *2 — | *2 — | *2 — | *2 — | *2 — |
| pressure-sensitive | | | | | | | | | |
| adhesive | | | | | | | | | |
| strength [N/25 mm] | | | | | | | | | |
| Pressure-sensitive | 0.06 | 0.02 | — *2 | *2 — | *2 — | *2 — | *2 — | *2 — | *2 — |
| adhesive | | | | | | | | | |
| strength after | | | | | | | | | |
| attachment at | | | | | | | | | |
| 50° C. for 10 days | | | | | | | | | |
| [N/25 mm] | | | | | | | | | |
| Residual | 0.53 | 1.66 | — *2 | *2 — | *2 — | *2 — | *2 — | *2 — | *2 — |
| adhesive | | | | | | | | | |
| strength [N/19 mm] | | | | | | | | | |

*1: The adhesive surface is roughened and air bubbles are not released.
*2: The adhesive surface is roughened and cannot be attached neatly, and hence measurement cannot be performed.

### Example 12

The surface protective film obtained in Example 1 was attached to a polarizing plate (manufactured by NITTO DENKO CORPORATION, trade name: “TEG1465DUHC”) as an optical member, to thereby provide an optical member having attached thereto a surface protective film.

### Example 13

The surface protective film obtained in Example 4 was attached to a polarizing plate (manufactured by NITTO DENKO CORPORATION, trade name: “TEG1465DUHC”) as an optical member, to thereby provide an optical member having attached thereto a surface protective film.

### Example 14

The surface protective film obtained in Example 8 was attached to a polarizing plate (manufactured by NITTO DENKO CORPORATION, trade name: “TEG1465DUHC”) as an optical member, to thereby provide an optical member having attached thereto a surface protective film.

### Example 15

The surface protective film (21) obtained in Example 10 was attached to a polarizing plate (manufactured by NITTO DENKO CORPORATION, trade name: “TEG1465DUHC”) as an optical member, to thereby provide an optical member having attached thereto a surface protective film.

### Example 16

The surface protective film obtained in Example 1 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 17

The surface protective film obtained in Example 4 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 18

The surface protective film obtained in Example 8 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 19

The surface protective film obtained in Example 10 was attached to a conductive film (manufactured by NITTO DENKO CORPORATION, trade name: “ELECRYSTA V270L-TFMP”) as an electronic member, to thereby provide an electronic member having attached thereto a surface protective film.

The surface protective film of the present invention may be used in any appropriate application. The surface protective film of the present invention preferably allows the contamination of an adherend to be extremely suppressed, and is preferably excellent in wettability and reworkability. Accordingly, the surface protective film of the present invention is preferably used for, for example, protecting a surface of a thin display member, a thin display apparatus, a thin optical film, or an electronic device.

What is claimed is:

1. A surface protective film, comprising a pressure-sensitive adhesive layer as an outermost layer,
wherein:
the pressure-sensitive adhesive layer contains, as a main component, a urethane-based pressure-sensitive adhesive containing a polyurethane-based resin; and
when a pressure-sensitive adhesive layer side of the surface protective film is attached to a glass plate at 50° C. for 10 days and then the surface protective film is peeled from the glass plate, a residual adhesive strength on the peeled surface side of the glass plate is 3.0 N/19 mm or more.

2. A surface protective film according to claim 1, wherein the surface protective film has a wetting rate with respect to a glass plate of 1.0 cm/sec or more.

3. A surface protective film according to claim 1, wherein the surface protective film has an initial pressure-sensitive adhesive strength with respect to a glass plate of 0.10 N/25 mm or less.

4. A surface protective film according to claim 1, wherein the surface protective film has a pressure-sensitive adhesive strength with respect to a glass plate after attachment at 50° C. for 10 days of 0.15 N/25 mm or less.

5. A surface protective film according to claim 1, wherein the polyurethane-based resin comprises a polyurethane-based resin obtained from a composition containing polyol (A) and a polyfunctional isocyanate compound (B).

6. A surface protective film according to claim 1, wherein the polyurethane-based resin comprises a polyurethane-based resin obtained from a composition containing a urethane prepolymer (C).

7. A surface protective film according to claim 1, wherein the polyurethane-based resin contains a leveling agent.

8. A surface protective film according to claim 1, wherein the surface protective film is used for protecting a surface of one of a thin display member, a thin display apparatus, a thin optical film, and an electronic device.
